(19) United States
(12) Patent Application Publication
(10) Pub. No.: US 2025/0093550 A1
(43) Pub. Date: Mar. 20, 2025

(54) ANTI-REFLECTIVE FILMS, METHODS FOR PREPARING THE SAME, AND DISPLAY PANELS

(71) Applicant: Shenzhen China Star Optoelectronics Semiconductor Display Technology Co., Ltd., Shenzhen (CN)

(72) Inventors: Miao DUAN, Shenzhen (CN); Su PAN, Shenzhen (CN); Miao ZHOU, Shenzhen (CN); Lixuan CHEN, Shenzhen (CN)

(21) Appl. No.: 18/542,849

(22) Filed: Dec. 18, 2023

(30) Foreign Application Priority Data
Sep. 20, 2023 (CN) 202311222967.X

(51) Int. Cl. G02B 1/11

(52) U.S. Cl. CPC G02B 1/11

(57) ABSTRACT

The present disclosure provides an anti-reflective film, a method for preparing the same, and a display panel; the anti-reflective film includes a substrate and a plurality of scattering portions dispersed on a surface of the substrate; a gap is provided between adjacent scattering portions, and each of the plurality of scattering portions includes an adhesive and a plurality of scattering particles dispersed in the adhesive.

### CROSS-REFERENCE TO RELATED APPLICATION

The present disclosure claims the priority to and benefit of Chinese Patent Application No. 202311222967.X, filed on Sep. 20, 2023, the disclosure of which is incorporated herein by reference in its entirety.

### TECHNICAL FIELD

The present disclosure relates to the field of display, and in particular, to anti-reflective films, methods for preparing the same, and display panels.

### BACKGROUND

With the development of display technology, people's demand for image quality is increasing. Ordinary displays will produce an obvious glare effect in strong light, and when strong light shines on the screen, it will be reflected, which will have a certain impact on display brightness and contrast of the displays, resulting in some areas of the image being blurry.

### SUMMARY

Embodiments of the present disclosure provide an anti-reflective film, including:
a substrate; and
a plurality of scattering portions dispersed on a surface of the substrate, in which a gap is provided between adjacent scattering portions, and each of the plurality of scattering portions includes an adhesive and a plurality of scattering particles dispersed in the adhesive.

Embodiments of the present disclosure further provide a method for preparing an anti-reflective film, including:
dispersing a plurality of scattering particles in a solvent to form a particle dispersion;
adding an adhesive to the particle dispersion to form an anti-reflective glue; and
coating the anti-reflective glue on a surface of a substrate, and curing the anti-reflective glue to form a plurality of scattering portions dispersed on the surface of the substrate, in which each of the plurality of scattering portions includes the adhesive and the scattering particles dispersed in the adhesive to form the anti-reflective film.

Embodiments of the present disclosure further provide a display panel, including:
a light-emitting substrate; and
an anti-reflective film disposed on the light-emitting substrate in a light output direction of the light-emitting substrate, in which the anti-reflective film includes:
a substrate; and
a plurality of scattering portions dispersed on a surface of the substrate, in which a gap is provided between adjacent scattering portions, and each of the plurality of scattering portions includes an adhesive and a plurality of scattering particles dispersed in the adhesive.

### BRIEF DESCRIPTION OF THE DRAWINGS

In order to explain technical solutions in embodiments of the present disclosure more clearly, the following will briefly introduce the drawings needed to be used in description of the embodiments. Apparently, the drawings in the following description are only some embodiments of the present disclosure. For ordinary skilled in the art, other drawings can be obtained from these drawings without paying creative effort.

FIG. 1 is a schematic cross-sectional structural diagram of an anti-glare film in related art.

FIG. 2 is another schematic cross-sectional structural diagram of an anti-glare film in related art.

FIG. 3 is a schematic cross-sectional structural diagram of an anti-reflective film according to some embodiments of the present disclosure.

FIG. 4 is a schematic scanning electron microscope (SEM) diagram of an anti-reflective film according to some embodiments of the present disclosure.

FIG. 5 is a schematic enlarged diagram of a part of the anti-reflective film shown in FIG. 4.

FIG. 6 is a flowchart of a method for preparing an anti-reflective film according to some embodiments of the present disclosure.

FIG. 7 is a schematic cross-sectional structural of a display panel according to some embodiments of the present disclosure.

### DETAILED DESCRIPTION

Specific embodiments that can be implemented in the present disclosure are described in the following with reference to the attached drawings. Directional terms mentioned in the present disclosure, such as [up], [down], [front], [back], [left], [right], [inside], [outside], [side], and the like, are only for reference to directions of the attached drawings. Therefore, the directional terms are used to explain and help understand the present disclosure, not to limit it. In the figures, units with similar structures are represented by the same numeral. In the attached drawings, thicknesses of some layers and areas have been exaggerated for clarity and ease of description. A size and a thickness of each component shown in the attached drawings are arbitrary, but the present disclosure is not limited to this.

In order to solve a technical problem of an obvious glare effect in the existing displays, the inventor of the present disclosure found in his research that an anti-glare film (AG) can be attached on the exterior of the displays (such as on a polarizer) to reduce a glare phenomenon and improve image quality of display.

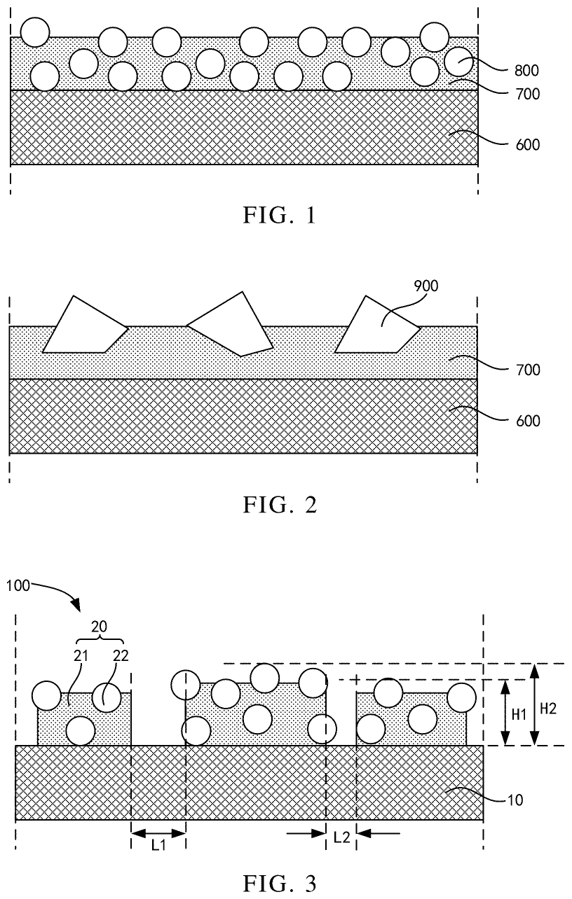

Specifically, referring to FIG. 1 and FIG. 2, FIG. 1 is a schematic cross-sectional structural diagram of an anti-glare film in related art, and FIG. 2 is another schematic cross-sectional structural diagram of an anti-glare film in related art. Generally, methods for preparing the anti-glare film mainly include particle-resin composite technology and phase separation technology. For the anti-glare film prepared by the particle-resin composite technology, a resin coating layer 700 is formed by overspreading the resin on the substrate 600, and scattering agent particles 800 are distributed inside or on a surface of the resin coating layer 700, as shown in FIG. 1. For the anti-glare film prepared by the phase separation technology, two or more different resin polymers are overspread on the substrate 600, and then undergo phase separation under the thermodynamic action; one resin polymer in the two or more different resin polymers forms the resin coating layer 700 in a dispersed phase, and another resin polymer in the two or more different resin polymers forms an island-shaped structure 900, as shown in FIG. 2.

However, although the anti-glare film mentioned above can solve the problem of the obvious glare effect in existing displays, for the particle-resin composite technology mentioned above, a high solid-content of particles is required to realize a high haze, and for the phase separation technology mentioned above, it is difficult to control the film-forming process. Based on the above, after further in-depth research, the inventor of the present disclosure has proposed an anti-reflective film to solve the problem of the anti-glare film mentioned above.

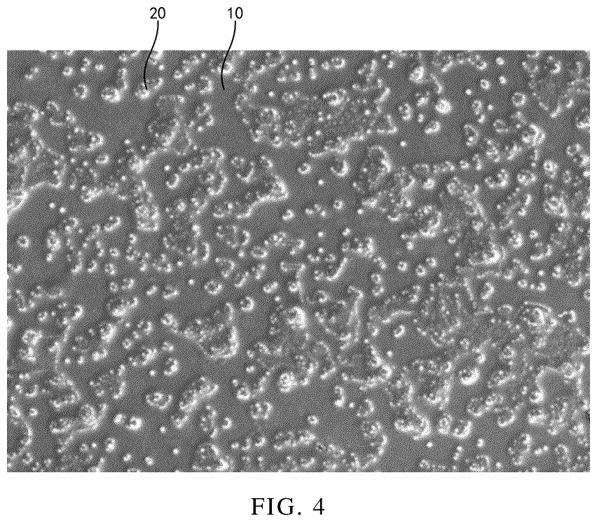

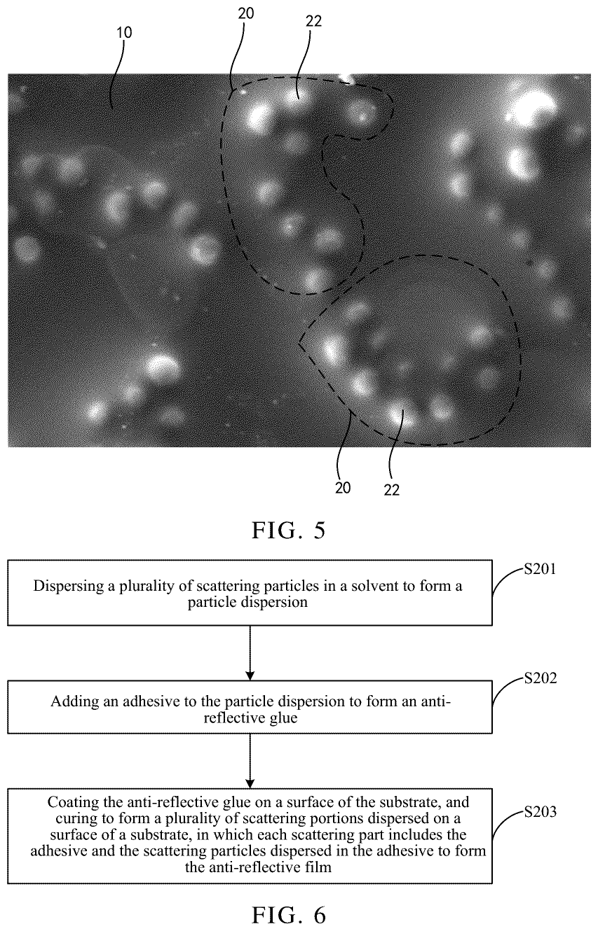

Referring to FIG. 3, FIG. 4, and FIG. 5, FIG. 3 is a schematic cross-sectional structural diagram of an anti-reflective film according to some embodiments of the present disclosure, FIG. 4 is a schematic scanning electron microscope (SEM) diagram of an anti-reflective film according to some embodiments of the present disclosure, and FIG. 5 is a schematic enlarged diagram of a part of the anti-reflective film shown in FIG. 4. Referring to FIG. 3, an anti-reflective film 100 includes a substrate 10 and a plurality of scattering portions 20 dispersed on a surface of the substrate 10. A gap is provided between adjacent scattering portions 20, and each scattering portion 20 includes an adhesive 21 and a plurality of scattering particles 22 dispersed in the adhesive 21. Optionally, the plurality of scattering portions 20 may be randomly dispersed on the surface of the substrate 10, further enhancing a scattering effect.

Both of the scattering particles 22 and the dispersed scattering portions 20 have the scattering effect on light, thereby enabling the anti-reflective film 100 to have an anti-glare effect, which solves the problem of the obvious glare effect in existing displays. Moreover, due to the fact that the dispersed scattering portions 20 have more interfaces compared to the anti-glare film formed by overspreading the resin on the entire substrate 600, and the more interfaces have a better scattering effect on light, it is possible to realize a higher haze at a lower solid-content of particles, thereby reducing material cost.

The structure of the anti-reflective film 100 will be described in detail below.

The substrate 10 of the anti-reflective film 100 is made of a film material with good mechanical strength and high light transmittance. For example, materials of the substrate 10 may include a transparent resin film material, such as polymethyl methacrylate (PMMA), polyethylene terephthalate (PET), polyethylene naphthalate (PEN), polycarbonate (PC), triacetyl cellulose (TAC), polyimide (PI), polyethylene (PE), polypropylene (PP), polyvinyl alcohol (PVA), polyvinyl chloride (PVC), cycloolefin copolymer (COC), or the like. Optionally, the transparent resin film material has light transmittance greater than 80%, preferably greater than 90%.

The scattering portions 20 are randomly dispersed on the substrate 10. The term of randomly dispersed refers to a random distribution of the plurality of scattering portions 20. For example, the gaps between the plurality of scattering portions 20 are different, and surface shapes and sizes of the plurality of scattering portions 20 are different. Specifically, as shown schematically in FIG. 3, there are three scattering portions 20, among which a gap between a first one of the three scattering portions 20 and a second one of the three scattering portions 20 is defined as L1, and a gap between the second one of the three scattering portions 20 and a third one of the three scattering portions 20 is defined as L2, L1 is greater than L2. As shown in the schematic SEM diagrams of FIG. 4 and FIG. 5, the plurality of scattering portions 20 are randomly dispersed on the substrate 10, each scattering portion 20 is an island-shaped structure, and specific shapes and sizes of the island-shaped structures of the plurality of scattering portions 20 are different. Some island-shaped structures have larger areas, while others have smaller areas.

Further, heights of the plurality of scattering portions 20 are different, as shown schematically in FIG. 3, among adjacent two scattering portions 20, one scattering portion 20 has a height of H1 and the other scattering portion 20 has a height of H2, and H2 is greater than H1. Correspondingly, in the schematic SEM diagrams of FIG. 4 and FIG. 5 corresponding to FIG. 3, the height of the scattering portion 20 with a larger area is higher, while the height of the scattering portion 20 with a smaller area is lower.

Each scattering portion 20 includes the adhesive 21 and a plurality of scattering particles 22 dispersed in the adhesive 21. The adhesive 21 does not overspread the entire substrate 10, but rather agglomerates around the scattering particles 22 and disperses together on the substrate 10 to form an island-shaped structure. The scattering particles 22 are dispersed within the adhesive 21, and the scattered particles 22 are located below or protruding from the surface of the substrate 10 away from the adhesive 21. Of course, it can be understood that, since each scattering portion 20 is an island-shaped structure, the structure of each scattering portion 20 may not have a sharp upper surface and a sharp side surface as shown in FIG. 3, FIG. 3 only illustrates the composition of the scattering portion 20 and the relationship between the plurality of scattering portions 20. The actual structure of the scattering portion 20 can be referred to the schematic SEM diagrams shown in FIG. 4 and FIG. 5.

Therefore, the scattering particles 22 protrude from a surface of the adhesive 21 away from the substrate 10, including protruding from an upper surface and a side surface of the adhesive 21 as shown in FIG. 3. Moreover, heights of the scattering particles 22 protruding from the surface of the adhesive 21 are not inconsistent, so that the scattering portion 20 has a rougher surface, thereby improving the scattering performance of the anti-reflective film 100.

Optionally, the scattering particles 22 include at least one of organic microspheres, inorganic microspheres, inorganic nanoparticles, and the like. When the scattering particles 22 are organic microspheres, it may include organic particles such as PC, polystyrene (PS), PMMA, polysiloxane, or the like. When the scattering particles 22 are inorganic microspheres, it may include inorganic particles such as silica, titanium dioxide, or the like. When the scattering particles 22 are inorganic nanoparticles, it may include inorganic nanoparticles such as silica, barium sulfate, or the like.

The adhesive 21 may include a resin prepolymer such as a (meth)acrylic resin, an epoxy resin, or the like.

In the embodiments of the present disclosure, by forming the scattering portions 20 with island-shaped structures on the substrate 10, not only can the scattering particles 22 in the scattering portion 20 form a light scattering effect, but the dispersed island-shaped structures also have a certain scattering effect on light. Therefore, it is possible to realize a higher haze at a low solid-content of particles, thereby reducing material cost.

Optionally, a content of the scattering particles 22 in the scattering portion 20 ranges from 5% to 50% by mass, a haze of the anti-reflective film 100 ranges from 10% to 70%, and light transmittance of the anti-reflective film 100 is greater than 89%. For example, the content of the scattering particles 22 in the scattering portion 20 is 10% by mass, and the haze of the anti-reflective film 100 ranges from 10% to 20%; or, the content of the scattering particles 22 in the scattering portion 20 is 20% by mass, and the haze of the anti-reflective film 100 ranges from 30% to 40%; or, the content of the scattering particles 22 in the scattering portion 20 is 40% by mass, and the haze of the anti-reflective film 100 ranges from 50% to 70%.

Embodiments of the present disclosure further provide a method for preparing an anti-reflective film, referring to FIGS. 3 to 6, FIG. 6 is a flowchart of the method for preparing the anti-reflective film according to some embodiments of the present disclosure. Referring to FIG. 6, the method for preparing the anti-reflective film includes the following step S201, step S202, and step S203.

At step S201, a plurality of scattering particles are dispersed in a solvent to form a particle dispersion.

Specifically, organic scattering particles or inorganic scattering particles, a modifier, and a surfactant are added to a single solvent or a mixed solvent, then heated and stirred at a temperature of 30° C. to 100° C. for 0.5 hour to 24 hours to obtain a dispersed uniformly particle dispersion. The modifier includes a silane coupling agent, or the like. The surfactant includes sodium stearate, polyethylene glycol, sodium dodecyl benzene sulfonate (SDBS), polyvinyl pyrrolidone (PVP), or the like. The solvent includes an alcohol-based solvent, an ester-based solvent, a ketone-based solvent, or the like.

At step S202, an adhesive is added to the particle dispersion to form an anti-reflective glue.

Specifically, a monomer, the adhesive 21, an initiator, an adjuvant, and a solvent are added to the particle dispersion to form the anti-reflective glue. The adhesive 21 in the anti-reflective glue includes a resin prepolymer such as acrylic resin, epoxy resin, or the like. The monomer includes an acrylic monomer with a monofunctional group, a bifunctional group, or a multi-functional group. The initiator includes an anionic initiator (AIBN), a free radical initiator (TPO), or the like. The adjuvant mainly includes a flatting agent, a defoaming agent, or the like.

At step S203, the anti-reflective glue is coated on a surface of the substrate, and cured to form a plurality of scattering portions dispersed on a surface of a substrate. Each scattering portion includes the adhesive and the scattering particles dispersed in the adhesive to form the anti-reflective film.

Specifically, the anti-reflective glue is coated on the surface of the substrate 10 using a coating process such as a wire rod coating method, and cured into a film by heating or UV curing to form the plurality of scattering portions 20 on the surface of the substrate 10, thereby forming the anti-reflective film 100.

The plurality of scattering portions 20 formed by curing into a film are dispersed on the substrate 10, and each scattering portion 20 includes the adhesive 21 and the scattering particles 22 dispersed in the adhesive 21. The adhesive 21 does not overspread the entire substrate 10, but aggregates around the scattering particles 22 and disperses together on the substrate 10 to form island-shaped structures, and gaps are provided between adjacent island-shaped structures and expose a portion of the substrate 10. Due to the formation of the plurality of scattering portions 20 by curing into a film, the plurality of scattering portions 20 can be randomly dispersed on the surface of the substrate 10.

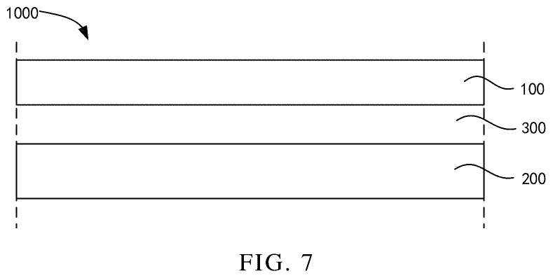

In the context, embodiments of the present disclosure further provide a display panel, referring to FIGS. 3 to 7, in which FIG. 7 is a schematic cross-sectional structural diagram of the display panel provided by some embodiments of the present disclosure. Referring to FIG. 7, a display panel 1000 includes a light-emitting substrate 200 and the anti-reflective film 100 as described in any one of the above-mentioned embodiments, or the anti-reflective film 100 prepared using the preparation method of the anti-reflective film as described in any one of the above-mentioned embodiments. The anti-reflective film 100 is disposed on the light-emitting substrate 200 in a light output direction of the light-emitting substrate 200.

Optionally, the display panel 1000 also includes a polarizer 300, which is disposed on the light-emitting substrate 200 in the light output direction of the light-emitting substrate 200, and on a side of the polarizer 300 away from the light-emitting substrate 200. The light-emitting substrate 200 may include a driving substrate and a light-emitting unit, and the driving substrate can drive the light-emitting unit to emit light, thereby achieving the emission of the light-emitting substrate 200. The anti-reflective film 100 may be attached onto the polarizer 300 through an adhesive layer, or the anti-reflective film 100 may also be directly prepared on the polarizer 300. When the anti-reflective film 100 is directly prepared on the polarizer 300, a substrate of the polarizer 300 can serve as the substrate 10 of the anti-reflective film 100.

Optionally, the display panel 1000 may be an organic light-emitting diode (OLED) display panel, a micro light-emitting diode (Micro LED) display panel, a sub-millimeter light-emitting diode (Mini LED) display panel, or the like. The display panel 1000 can be used in an electronic device with display function, such as a mobile phone, a tablet, a laptop, a game console, a digital camera, a car navigation device, an electronic billboard, an automatic teller machine, or the like.

From the above-mentioned embodiments, it can be seen that:
the present disclosure provides the anti-reflective film, the preparation method thereof, and the display panel; the anti-reflective film includes the substrate and the plurality of scattering portions dispersed on a surface of the substrate, and gaps are provided between adjacent scattering portions; each of the plurality of scattering portions includes the adhesive and the scattering particles dispersed in the adhesive. Both of the scattering particles and the dispersed scattering portions have the scattering effect on light, so that the anti-reflective film has an anti-glare effect, solving the technical problem of the obvious glare effect in existing displays.

In the above-mentioned embodiments, the description of each embodiment has its own emphasis. For the parts that are not detailed in one embodiment, please refer to the relevant description of other embodiments.

The above description provides a detailed introduction to the embodiments of the present disclosure. The embodiments in this context are used to explain the principles and implementation methods of the present disclosure. The explanation of the above-mentioned embodiments are only used to help understand the technical solutions and core ideas of the present disclosure; ordinary skilled in the art should understand that they can still modify the technical solutions recorded in the above-mentioned embodiments, or equivalently replace some of the technical features; and these modifications or replacements do not separate the essence of the corresponding technical solutions from the scope of the technical solutions of the various embodiments of the present disclosure.

What is claimed is:

1. An anti-reflective film comprising:
a substrate; and
a plurality of scattering portions dispersed on a surface of the substrate, wherein a gap is provided between adjacent scattering portions, and each of the plurality of scattering portions comprises an adhesive and a plurality of scattering particles dispersed in the adhesive.

2. The anti-reflective film of claim 1, wherein the scattering particles are dispersed within the adhesive, and the scattered particles are located below or protruding from the surface of the substrate away from the adhesive.

3. The anti-reflective film of claim 1, wherein at least one of the plurality of scattering portions is an island-shaped structure.

4. The anti-reflective film of claim 1, wherein the scattering particles comprise at least one of organic microspheres, inorganic microspheres, and inorganic nanoparticles.

5. The anti-reflective film of claim 1, wherein the adhesive comprises a (meth)acrylic resin or an epoxy resin.

6. The anti-reflective film of claim 1, wherein a content of the scattering particles in at least one of the plurality of scattering portions ranges from 5% to 50% by mass, and a haze of the anti-reflective film ranges from 10% to 70%.

7. The anti-reflective film of claim 6, wherein the content of the scattering particles in at least one of the plurality of scattering portions is 20% by mass, and the haze of the anti-reflective film ranges from 30% to 40%.

8. The anti-reflective film of claim 1, wherein heights of the plurality of scattering portions are different.

9. The anti-reflective film of claim 1, wherein heights of the scattering particles in the plurality of scattering portions are different.

10. The anti-reflective film of claim 1, wherein the scattering particles comprise at least one of polycarbonate, polystyrene, polymethyl methacrylate, polysiloxane, silica, titanium dioxide, silica, and barium sulfate.

11. The anti-reflective film of claim 1, wherein light transmittance of the anti-reflective film is greater than 89%.

12. The anti-reflective film of claim 1, wherein a content of the scattering particles in at least one of the plurality of scattering portions ranges from 5% to 50% by mass, a haze of the anti-reflective film ranges from 10% to 70%, and light transmittance of the anti-reflective film is greater than 89%.

13. A method for preparing an anti-reflective film comprising:
dispersing scattering particles in a solvent to form a particle dispersion;
adding an adhesive to the particle dispersion to form an anti-reflective glue; and
coating the anti-reflective glue on a surface of a substrate, and curing the anti-reflective glue to form a plurality of scattering portions dispersed on the surface of the substrate, wherein each of the plurality of scattering portions comprises the adhesive and the scattering particles dispersed in the adhesive to form the anti-reflective film.

14. The method for preparing the anti-reflective film of claim 13, wherein the step of dispersing the scattering particles in the solvent to form the particle dispersion comprises:
adding organic scattering particles or inorganic scattering particles, a modifier, and a surfactant to a single solvent or a mixed solvent, heating and stirring at a temperature of 30° C. to 100° C. for 0.5 hour to 24 hours, to obtain a uniformly dispersed particle dispersion.

15. A display panel comprising:
a light-emitting substrate; and
an anti-reflective film disposed on the light-emitting substrate in a light output direction of the light-emitting substrate, wherein the anti-reflective film comprises:
a substrate; and
a plurality of scattering portions dispersed on a surface of the substrate, wherein a gap is provided between adjacent scattering portions, and each of the plurality of scattering portions comprises an adhesive and a plurality of scattering particles dispersed in the adhesive.

16. The display panel of claim 15, wherein the scattering particles are dispersed within the adhesive, and the scattered particles are located below or protruding from the surface of the substrate away from the adhesive.

17. The display panel of claim 15, wherein at least one of the plurality of scattering portions is an island-shaped structure.

18. The display panel of claim 15, wherein the scattering particles comprise at least one of organic microspheres, inorganic microspheres, and inorganic nanoparticles.

19. The display panel of claim 15, wherein the adhesive comprises a (meth)acrylic resin or an epoxy resin.

20. The display panel of claim 15, wherein a content of the scattering particles in at least one of the plurality of scattering portions ranges from 5% to 50% by mass, and a haze of the anti-reflective film ranges from 10% to 70%.
